(19) United States
(12) Patent Application Publication
(10) Pub. No.: US 2009/0098363 A1
(43) Pub. Date: Apr. 16, 2009

(54) MAGNESIUM HYDROXIDE WITH IMPROVED COMPOUNDING AND VISCOSITY PERFORMANCE

(75) Inventors: Rene Gabriel Erich Herbiet, Eupen (BE); Winfried Kurt Albert Toedt, Steffin-Auel (DE); Wolfgang Hardtke, Niederkassel (DE); Hermann Rautz, Graz (AT); Christian Alfred Kienesberger, Kapfenberg (AT)

Correspondence Address: ALBEMARLE CORPORATION;PATENT DEPARTMENT, 451 FLORIDA STREET, BATON ROUGE, LA, 70801, US

(73) Assignee: Albemarle Corporation, Baton Rouge, LA (US)

(21) Appl. No.: 12/293,851

(22) PCT Filed: Mar. 16, 2007
(86) PCT No.: PCT/US07/63886

§ 371 Date: Sep. 22, 2008

Related U.S. Application Data
(60) Provisional application No. 60/788,246, filed on Mar. 31, 2006.

(51) Int. Cl. B32B 5/16; C08K 3/22; F26B 3/02; F26B 17/00

(52) U.S. Cl. 428/327; 428/402; 524/436; 521/92; 34/443; 34/493; 34/500

(57) ABSTRACT

Novel magnesium hydroxide flame retardants, a method of making them from filter cakes, and their use.

### FIELD OF THE INVENTION

The present invention relates to mineral flame retardants. More particularly the present invention relates to novel magnesium hydroxide flame retardants, methods of making them, and their use.

### BACKGROUND OF THE INVENTION

Many processes for making magnesium hydroxide exist. For example, in conventional magnesium processes, it is known that magnesium hydroxide can be produced by hydration of magnesium oxide, which is obtained by spray roasting a magnesium chloride solution, see for example U.S. Pat. No. 5,286,285 and European Patent number EP 0427817. It is also known that a Mg source such as iron bitten, seawater or dolomite can be reacted with an alkali source such as lime or sodium hydroxide to form magnesium hydroxide particles, and it is also known that a Mg salt and ammonia can be allowed to react and form magnesium hydroxide crystals.

The industrial applicability of magnesium hydroxide has been known for some time. Magnesium hydroxide has been used in diverse applications from use as an antacid in the medical field to use as a flame retardant in industrial applications. In the flame retardant area, magnesium hydroxide is used in synthetic resins such as plastics and in wire and cable applications to impart flame retardant properties. The compounding performance and viscosity of the synthetic resin containing the magnesium hydroxide is a critical attribute that is linked to the magnesium hydroxide. In the synthetic resin industry, the demand for better compounding performance and viscosity has increased for obvious reasons, i.e. higher throughputs during compounding and extrusion, better flow into molds, etc. As this demand increases, the demand for higher quality magnesium hydroxide particles and methods for making the same also increases.

### BRIEF DESCRIPTION OF THE FIGURES

FIG. 1 shows the specific pore volume V of a magnesium hydroxide intrusion test run as a function of the applied pressure for a commercially available magnesium hydroxide grade.

FIG. 2 shows the specific pore volume V of a magnesium hydroxide intrusion test run as a function of the pore radius r.

FIG. 3 shows the normalized specific pore volume of a magnesium hydroxide intrusion test run, the graph was generated with the maximum specific pore volume set at 100%, and the other specific volumes were divided by this maximum value.

### SUMMARY OF THE INVENTION

In one embodiment, the present invention relates to a process comprising:

mill drying a filter cake comprising from about 35 to about 99 wt. % magnesium hydroxide based on the total weight of the filter cake.

In another embodiment, the present invention relates to magnesium hydroxide particles having:

a d₅₀ of less than about 3.5 μm

a BET specific surface area of from about 1 to about 15; and

a median pore size diameter in the range of from about 0.01 to about 0.5 μm,

wherein said magnesium hydroxide particles are produced by mill drying a filter cake comprising in the range of from about 35 to about 99 wt. % magnesium hydroxide, based on the total weight of the filter cake.

### DETAILED DESCRIPTION OF THE INVENTION

The process of the present invention comprises mill drying a filter cake comprising in the range of from about comprising in the range of from about 35 to about 99 wt. %, preferably in the range of from about 35 to about 80 wt. %, more preferably in the range of from about 40 to about 70 wt. %, magnesium hydroxide, based on the total weight of the filter cake. The remainder of the filter cake is water, preferably desalted water. In some embodiments, the filter cake may also contain a dispersing agent. Non-limiting examples of dispersing agents include polyacrylates, organic acids, naphtalensulfonate/Formaldehydeondensat, fatty-alcohole-polyglycol-ether, polypropylene-ethylenoxid, polyglycol-ester, polyamine-ethylenoxid, phosphate, polyvinylalcohole.

The filter cake can be obtained from any process used to produce magnesium hydroxide particles. In an exemplary embodiment, the filter cake is obtained from a process that comprises adding water to magnesium oxide, preferably obtained from spray roasting a magnesium chloride solution, to form a magnesium oxide water suspension. The suspension typically comprises from about 1 to about 85 wt. % magnesium oxide, based on the total weight of the suspension. However, the magnesium oxide concentration can be varied to fail within the ranges described above. The water and magnesium oxide suspension is then allowed to react under conditions that include temperatures ranging from about 50° C. to about 100° C. and constant stirring, thus obtaining a mixture comprising magnesium hydroxide particles and water. This mixture is then filtered to obtain the filter cake used in the practice of the present invention. The filter cake can be directly mill dried, or it can be washed one, or in some embodiments more than one, times with de-salted water, and then mill dried according to the present invention

By mill drying, it is meant that the filter cake is dried in a turbulent hot air-stream in a mill drying unit. The mill drying unit comprises a rotor that is firmly mounted on a solid shaft that rotates at a high circumferential speed. The rotational movement in connection with a high air through-put converts the through-flowing hot air into extremely fast air vortices which take up the filter cake to be dried, accelerate it, and distribute and dry the filter cake to produce magnesium hydroxide particles that have a larger surface area, as determined by BET described above, then the starting magnesium hydroxide particles in the filter cake. After having been dried completely, the magnesium hydroxide particles are transported via the turbulent air out of the mill and separated from the hot air and vapors by using conventional filter systems.

The throughput of the hot air used to dry the filter cake is typically greater than about 3,000 Bm³/h, preferably greater than about to about 5,000 Bm³/h, more preferably from about 3,000 Bm³/h to about 40,000 Bm³/h, and most preferably from about 5,000 Bm³/h to about 30,000 Bm³/h.

In order to achieve throughputs this high, the rotor of the mill drying unit typically has a circumferential speed of greater than about 40 m/sec, preferably greater than about 60 m/sec, more preferably greater than 70 m/sec, and most preferably in a range of about 70 m/sec to about 140 m/sec. The high rotational speed of the motor and high throughput of hot air results in the hot air stream having a Reynolds number greater than about 3,000.

The temperature of the hot air stream used to mill dry the filter cake is generally greater than about 150° C., preferably greater than about 270° C. In a more preferred embodiment, the temperature of the hot air stream is in the range of from about 150° C. to about 550° C., most preferably in the range of from about 270° C. to about 500° C.

As stated above, the mill drying of the filter cake results in magnesium hydroxide particle having a larger surface area, as determined by BET described above, then the starting magnesium hydroxide particles in the filter cake. Typically, the BET of the mill-dried magnesium hydroxide is greater than about 10% greater than the magnesium hydroxide particles in the filter cake. Preferably the BET of the mill-dried magnesium hydroxide is from about 10% to about 40% greater than the magnesium hydroxide particles in the filter cake. More preferably the BET of the mill-dried magnesium hydroxide is from about 10% to about 25% greater than the magnesium hydroxide particles in the filter cake.

Thus, the magnesium hydroxide particles are also characterized as having a BET specific surface area, as determined by DIN-66132, in the range of from about 1 to 15 m²/g. In one preferred embodiment, the magnesium hydroxide particles according to the present invention have a BET specific surface in the range of from about 1 to about 5 m²/g, more preferably in the range of from about 2.5 to about 4 m²/g. In another preferred embodiment, the magnesium hydroxide particles according to the present invention have a BET specific surface of in the range of from about 3 to about 7 m²/g, more preferably in the range of from about 4 to about 6 m²/g. In another preferred embodiment, the magnesium hydroxide particles according to the present invention have a BET specific surface in the range of from about 6 to about 10 m²/g, more preferably in the range of from about 7 to about 9 m²/g. In yet another preferred embodiment, the magnesium hydroxide particles according to the present invention have a BET specific surface area in the range of from about 8 to about 12 m²/g, more preferably in the range of from about 9 to about 11 m²/g.

The magnesium hydroxide particles produced by the mill-drying process of the present invention are also characterized as having a d₅₀ of less than about 3.5 μm. In one preferred embodiment, the magnesium hydroxide particles of the present invention are characterized as having a d₅₀ in the range of from about 1.2 to about 3.5 μm, more preferably in the range of from about 1.45 to about 2.8 μm. In another preferred embodiment, the magnesium hydroxide particles are characterized as having a d₅₀ in the range of from about 0.9 to about 2.3 μm, more preferably in the range of from about 1.25 to about 1.65 μm. In another preferred embodiment, the magnesium hydroxide particles are characterized as having a d₅₀ in the range of from about 0.5 to about 1.4 μm, more preferably in the range of from about 0.8 to about 1.1 μm. In still yet another preferred embodiment, the magnesium hydroxide particles are characterized as having a d₅₀ in the range of from about 0.3 to about 1.3 μm, more preferably in the range of from about 0.65 to about 0.95 μm.

It should be noted that the d₅₀ measurements reported herein were measured by laser diffraction according to ISO 9276 using a Malvern Mastersizer S laser diffraction machine. To this purpose, a 0.5% solution with EXTRAN MA02 from Merck/Germany is used and ultrasound is applied. EXTRAN MA02 is an additive to reduce the water surface tension and is used for cleaning of alkali-sensitive items. It contains anionic and non-ionic surfactants, phosphates, and small amounts of other substances. The ultrasound is used to de-agglomerate the particles.

The magnesium hydroxide particles are also characterized as having a specific median average pore radius (r₅₀). The r₅₀ of the magnesium hydroxide particles according to the present invention can be derived from mercury porosimetry. The theory of mercury porosimetry is based on the physical principle that a non-reactive, non-wetting liquid will not penetrate pores until sufficient pressure is applied to force its entrance. Thus, the higher the pressure necessary for the liquid to enter the pores, the smaller the pore size. A smaller pore size was found to correlate to better wettability of the magnesium hydroxide particles. The pore size of the magnesium hydroxide particles can be calculated from data derived from mercury porosimetry using a Porosimeter 2000 from Carlo Erba Strumentazione, Italy. According to the manual of the Porosimeter 2000, the following equation is used to calculate the pore radius r from the measured pressure p: r=−2γ cos(θ)/p; wherein θ is the wetting angle and γ is the surface tension. The measurements taken herein used a value of 141.3° for θ and γ was set to 480 dyn/cm.

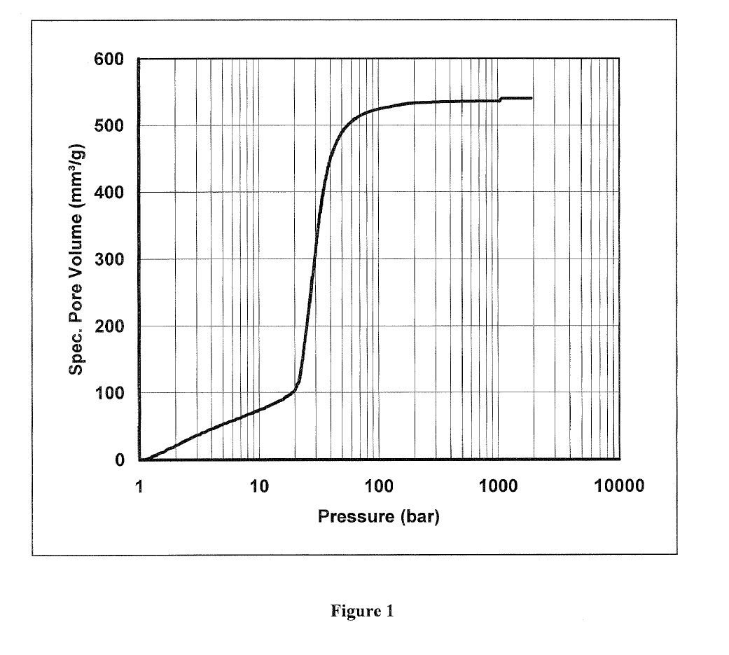

In order to improve the repeatability of the measurements, the pore size was calculated from a second magnesium hydroxide intrusion test run, as described in the manual of the Porosimeter 2000. The second test run was used because the inventors observed that an amount of mercury having the volume V₀ remains in the sample of the magnesium hydroxide particles after extrusion, i.e. after release of the pressure to ambient pressure. Thus, the r₅₀ can be derived from this data as explained below with reference to FIGS. 1, 2, and 3.

In the first test run, a magnesium hydroxide sample was prepared as described in the manual of the Porosimeter 2000, and the pore volume was measured as a function of the applied intrusion pressure p using a maximum pressure of 2000 bar. The pressure was released and allowed to reach ambient pressure upon completion of the first test run. A second intrusion test run (according to the manual of the Porosimeter 2000) utilizing the same sample, unadulterated, from the first test run was performed, where the measurement of the specific pore volume V(p) of the second test run takes the volume V₀ as a new starting volume, which is then set to zero for the second test run.

In the second intrusion test run, the measurement of the specific pore volume V(p) of the sample was again performed as a function of the applied intrusion pressure using a maximum pressure of 2000 bar. FIG. 1 shows the specific pore volume V of the second intrusion test run (using the same sample as the first test run) as a function of the applied intrusion pressure for a commercially available magnesium hydroxide grade.

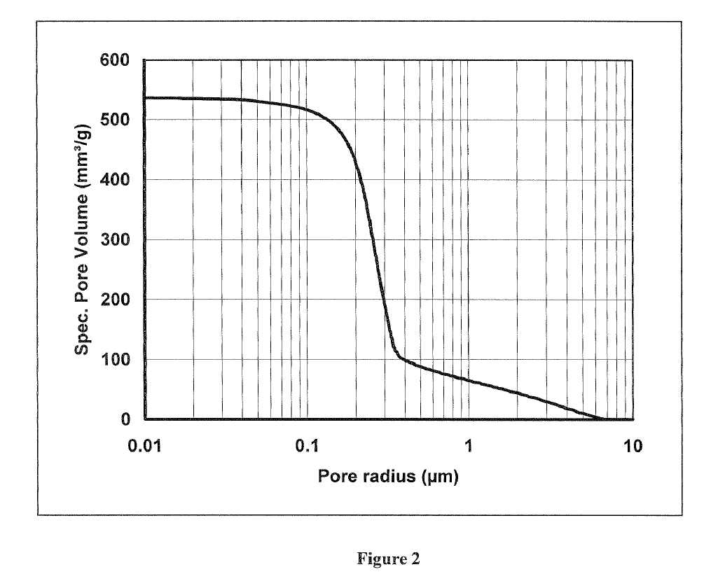

From the second magnesium hydroxide intrusion test run, the pore radius r was calculated by the Porosimeter 2000 according to the formula r=−2γ cos(θ)/p; wherein θ is the wetting angle, γ is the surface tension and p the intrusion pressure. For all r measurements taken herein, used a value of 141.3° for θ was used and γ was set to 480 dyn/cm. The specific pore volume can thus be represented as a function of the pore radius r. FIG. 2 shows the specific pore volume V of the second intrusion test run (using the same sample) as a function of the pore radius r.

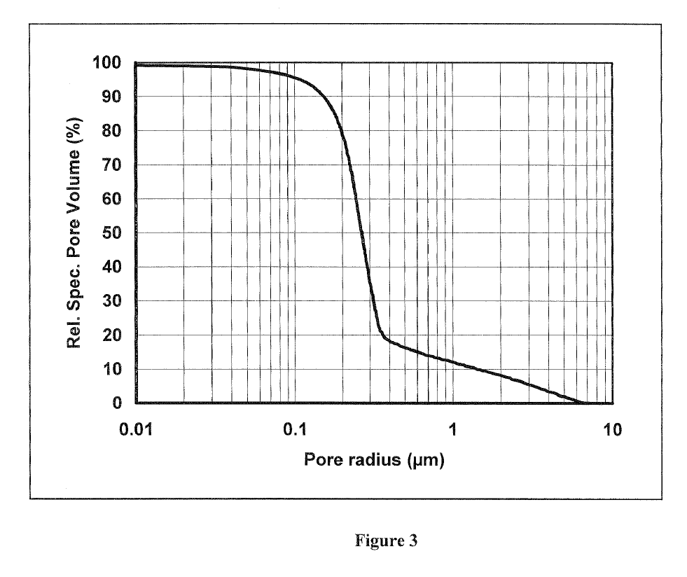

FIG. 3 shows the normalized specific pore volume of the second intrusion test run as a function of the pore radius r, i.e. in this curve, the maximum specific pore volume of the second intrusion test run was set to 100% and the other specific volumes were divided by this maximum value. The pore radius at 50% of the relative specific pore volume, by definition, is called median pore radius r₅₀ herein. For example, according to FIG. 3, the median pore radius r₅₀ of the commercially available magnesium hydroxide is 0.248 μm.

The procedure described above was repeated using a sample of the magnesium hydroxide particles according to the present invention, and the magnesium hydroxide particles were found to have an r₅₀ in the range of from about 0.01 to about 0.5 μm. In a preferred embodiment of the present invention, the r₅₀ of the magnesium hydroxide particles is in the range of from about 0.20 to about 0.4 μm, more preferably in the range of from about 0.23 to about 0.4 μm, most preferably in the range of from about 0.25 to about 0.35 μm. In another preferred embodiment, the r₅₀ is in the range of from about 0.15 to about 0.25 μm, more preferably in the range of from about 0.16 to about 0.23 μm, most preferably in the range of from about 0.175 to about 0.22 μm. In yet another preferred embodiment, the r₅₀ is in the range of from about 0.1 to about 0.2 μm, more preferably in the range of from about 0.1 to about 0.16 μm, most preferably in the range of from about 0.12 to about 0.15 μm. In still yet another preferred embodiment, the r₅₀ is in the range of from about 0.05 to about 0.15 μm, more preferably in the range of from about 0.07 to about 0.13 μm, most preferably in the range of from about 0.1 to about 0.12 μm.

In some embodiments, the magnesium hydroxide particles of the present invention are further characterized as having a linseed oil absorption in the range of from about 15% to about 40%. In one preferred embodiment, the magnesium hydroxide particles according to the present invention can further be characterized as having a linseed oil absorption in the range of from about 16 m²/g to about 25%, more preferably in the range of from about 17% to about 25%, most preferably in the range of from about 19% to about 24%. In another preferred embodiment, the magnesium hydroxide particles according to the present invention can further be characterized as having a linseed oil absorption in the range of from about 20% to about 28%, more preferably in the range of from about 21% to about 27%, most preferably in the range of from about 22% to about 26%. In yet another preferred embodiment, the magnesium hydroxide particles according to the present invention can further be characterized as having a linseed oil absorption in the range of from about 24% to about 32%, more preferably in the range of from about 25% to about 31%, most preferably in the range of from about 26% to about 30%. In still yet another preferred embodiment, the magnesium hydroxide particles according to the present invention can further be characterized as having a linseed oil absorption in the range of from about 27% to about 34%, more preferably in the range of from about 28% to about 33%, most preferably in the range of from about 28% to about 32%.

The magnesium hydroxide particles according to the present invention can be used as a flame retardant in a variety of synthetic resins. Non-limiting examples of thermoplastic resins where the magnesium hydroxide particles find use include polyethylene, polypropylene, ethylene-propylene copolymer, polymers and copolymers of C₂ to C₈ olefins (α-olefin) such as polybutene, poly(4-methylpentene-1) or the like, copolymers of these olefins and diene, ethylene-acrylate copolymer, polystyrene, ABS resin, AAS resin, AS resin, MBS resin, ethylene-vinyl chloride copolymer resin, ethylene-vinyl acetate copolymer resin, ethylene-vinyl chloride-vinyl acetate graft polymer resin, vinylidene chloride, polyvinyl chloride, chlorinated polyethylene, chlorinated polypropylene, vinyl chloride-propylene copolymer, vinyl acetate resin, phenoxy resin, polyacetal, polyamide, polyimide, polycarbonate, polysulfone, polyphenylene oxide, polyphenylene sulfide, polyethylene terephthalate, polybutylene terephthalate, methacrylic resin and the like. Further examples of suitable synthetic resins include thermosetting resins such as epoxy resin, phenol resin, melamine resin, unsaturated polyester resin, alkyd resin and urea resin and natural or synthetic rubbers such as EPDM, butyl rubber, isoprene rubber, SBR, NIR, urethane rubber, polybutadiene rubber, acrylic rubber, silicone rubber, fluoro-elastomer, NBR and chloro-sulfonated polyethylene are also included. Further included are polymeric suspensions (lattices).

Preferably, the synthetic resin is a polypropylene-based resin such as polypropylene homopolymers and ethylene-propylene copolymers; polyethylene-based resins such as high-density polyethylene, low-density polyethylene, straight-chain low-density polyethylene, ultra low-density polyethylene, EVA (ethylene-vinyl acetate resin), EEA (ethylene-ethyl acrylate resin), EMA (ethylene-methyl acrylate copolymer resin), EAA (ethylene-acrylic acid copolymer resin) and ultra high molecular weight polyethylene; and polymers and copolymers of C₂ to C₈ olefins (α-olefin) such as polybutene and poly(4-methylpentene-1), polyamide, polyvinyl chloride and rubbers. In a more preferred embodiment, the synthetic resin is a polyethylene-based resin.

The inventors have discovered that by using the magnesium hydroxide particles according to the present invention as flame retardants in synthetic resins, better compounding performance and better viscosity performance, i.e. a lower viscosity, of the magnesium hydroxide containing synthetic resin can be achieved. The better compounding performance and better viscosity is highly desired by those compounders, manufactures, etc. producing final extruded or molded articles out of the magnesium hydroxide containing synthetic resin.

By better compounding performance, it is meant that variations in the amplitude of the energy level of compounding machines like Buss Ko-kneaders or twin screw extruders needed to mix a synthetic resin containing magnesium hydroxide particles according to the present invention are smaller than those of compounding machines mixing a synthetic resin containing conventional magnesium hydroxide particles. The smaller variations in the energy level allows for higher throughputs of the material to be mixed or extruded and/or a more uniform (homogenous) material.

By better viscosity performance, it is meant that the viscosity of a synthetic resin containing magnesium hydroxide particles according to the present invention is lower than that of a synthetic resin containing conventional magnesium hydroxide particles. This lower viscosity allows for faster extrusion and/or mold filling, less pressure necessary to extrude or to fill molds, etc., thus increasing extrusion speed and/or decreasing mold fill times and allowing for increased outputs.

Thus, in one embodiment, the present invention relates to a flame retarded polymer formulation comprising at least one synthetic resin, in some embodiments only one, as described above, and a flame retarding amount of magnesium hydroxide particles according to the present invention, and molded and/or extruded article made from the flame retarded polymer formulation.

By a flame retarding amount of the magnesium hydroxide, it is generally meant in the range of from about 5 wt % to about 90 wt %, based on the weight of the flame retarded polymer formulation, and more preferably from about 20 wt % to about 70 wt %, on the same basis. In a most preferred embodiment, a flame retarding amount is from about 30 wt % to about 65 wt % of the magnesium hydroxide particles, on the same basis.

The flame retarded polymer formulation can also contain other additives commonly used in the art. Non-limiting examples of other additives that are suitable for use in the flame retarded polymer formulations of the present invention include extrusion aids such as polyethylene waxes, Si-based extrusion aids, fatty acids; coupling agents such as amino-, vinyl- or alkyl silanes or maleic acid grafted polymers; barium stearate or calcium stearate; organoperoxides; dyes; pigments; fillers; blowing agents; deodorants; thermal stabilizers; antioxidants; antistatic agents; reinforcing agents; metal scavengers or deactivators; impact modifiers; processing aids; mold release aids, lubricants; anti-blocking agents; other flame retardants; UV stabilizers; plasticizers; flow aids; and the like. If desired, nucleating agents such as calcium silicate or indigo can be included in the flame retarded polymer formulations also. The proportions of the other optional additives are conventional and can be varied to suit the needs of any given situation.

The methods of incorporation and addition of the components of the flame-retarded polymer formulation and the method by which the molding is conducted is not critical to the present invention and can be any known in the art so long as the method selected involves uniform mixing and molding. For example, each of the above components, and optional additives if used, can be mixed using a Buss Ko-kneader, internal mixers, Farrel continuous mixers or twin screw extruders or in some cases also single screw extruders or two roll mills, and then the flame retarded polymer formulation molded in a subsequent processing step. Further, the molded article of the flame-retardant polymer formulation may be used after fabrication for applications such as stretch processing, emboss processing, coating, printing, plating, perforation or cutting. The kneaded mixture can also be inflation-molded, injection-molded, extrusion-molded, blow-molded, press-molded, rotation-molded or calender-molded.

In the case of an extruded article, any extrusion technique known to be effective with the synthetic resin mixture described above can be used. In one exemplary technique, the synthetic resin, magnesium hydroxide particles, and optional components, if chosen, are compounded in a compounding machine to form a flame-retardant resin formulation as described above. The flame-retardant resin formulation is then heated to a molten state in an extruder, and the molten flame-retardant resin formulation is then extruded through a selected die to form an extruded article or to coat for example a metal wire or a glass fiber used for data transmission.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. For example, when discussing the oil absorption of the magnesium hydroxide product particles, it is contemplated that ranges from about 15% to about 17%, about 15% to about 27%, etc. are within the scope of the present invention.

What is claimed:

1. A process comprising:
a) mill drying a filter cake comprising in the range of from about 35 to about 99 wt. % magnesium hydroxide, based on the total weight of the filter cake, thereby producing mill-dried magnesium hydroxide particles.

2. The process according to claim 1 wherein said filter cake comprises in the range of from about 40 to about 70 wt. %, magnesium hydroxide, based on the total weight of the filter cake.

3. The process according to claim 1 wherein said filter cake comprises in the range of from about 35 to about 70 wt. %, magnesium hydroxide, based on the total weight of the filter cake.

4. The process according to claim 1 wherein the mill drying is effected by passing the filter cake through a mill drier operated under conditions including a throughput of a hot air stream greater than about 3000 Bm³/h, a rotor circumferential speed of greater than about 40 m/sec, wherein said hot air stream has a temperature of greater than about 150° C. and a Reynolds number greater than about 3000.

5. The process according to claim 2 wherein the mill drying is effected by passing the slurry or filter cake through a mill drier operated under conditions including a throughput of a hot air stream greater than about 3000 Bm³/h to about 40000 Bm³/h, a rotor circumferential speed of greater than about 70 m/sec, wherein said hot air stream has a temperature of from about 150° C. to about 550° C. and a Reynolds number greater than about 3000.

6. The process according to claim 4 wherein the BET of the mill-dried magnesium hydroxide is more than about 10% greater than the magnesium hydroxide particles in the slurry or filter cake.

7. The process according to claim 5 wherein the BET of the mill-dried magnesium hydroxide is in the range of from about 10% to about 40% greater than the magnesium hydroxide particles in the filter cake.

8. The process according to claim 1 wherein said filter cake is obtained from a process comprising adding water to magnesium oxide to form a magnesium oxide water suspension comprising from about 1 to about 85 wt. % magnesium oxide, based on the suspension, and allowing the water and magnesium oxide to react under conditions that include temperatures ranging from about 50° C. to about 100° C. and constant stirring, thus obtaining a mixture comprising magnesium hydroxide particles and water and filtering said mixture.

9. The process according to claim 8 wherein the magnesium oxide is obtained from spray roasting a magnesium chloride solution.

10. The process according to claim 9 wherein said process further comprises washing said filter cake with water prior to mill drying.

11. The process according to claim 10 wherein said water is desalted water.

12. The use of a mill dryer to produce mill-dried magnesium hydroxide particles from a filter cake.

13. Magnesium hydroxide particles having:
a) a d₅₀ of less than about 3.5 μm
b) a BET specific surface area in the range of from about 1 to about 15;
c) a median pore radius, r₅₀, in the range of from about 0.01 to about 0.5 μm; and,
d) a linseed oil absorption in the range of from about 15% to about 40%.
wherein said magnesium hydroxide particles are produced by mill drying a filter cake comprising in the range of from about 35 to about 99 wt. % magnesium hydroxide, based on the total weight of the filter cake.

14. The magnesium hydroxide particles according to claim 13 wherein the d₅₀ is in the range of from about 1.2 to about 3.5 μm.

15. The magnesium hydroxide particles according to claim 13 wherein the d₅₀ is in the range of from about 0.9 to about 2.3 μm.

16. The magnesium hydroxide particles according to claim 13 wherein the d₅₀ is in the range of from about 0.5 to about 1.4 μm.

17. The magnesium hydroxide particles according to claim 13 wherein the d₅₀ is in the range of from about 0.3 to about 1.3 μm.

18. The magnesium hydroxide particles according to any of claims 14 wherein the BET specific surface area is in the range of from about 2.5 to about 4 m²/g or in the range of from about 1 to about 5 m²/g.

19. The magnesium hydroxide particles according to any of claims 15 wherein the BET specific surface area is in the range of from about 3 to about 7 m²/g.

20. The magnesium hydroxide particles according to claim 16 wherein the BET specific surface area is in the range of from about 4 to about 6 m²/g.

21. The magnesium hydroxide particles according to claim 16 wherein the BET specific surface area is in the range of from about 7 to about 9 m²/g or is in the range of from about 6 to about 10 m²/g.

22. The magnesium hydroxide particles according to claim 17 wherein the BET specific surface area is in the range of from about 8 to about 12 m²/g or is in the range of from about 9 to about 11 m²/g.

23. The magnesium hydroxide particles according to claim 19 wherein the r₅₀ is in the range of from about 0.2 to about 0.4 μm.

24. The magnesium hydroxide particles according to claim 20 wherein the r₅₀ is in the range of from about 0.15 to about 0.25 μm.

25. The magnesium hydroxide particles according to claim 21 wherein the r₅₀ is in the range of from about 0.1 to about 0.2 μm.

26. The magnesium hydroxide particles according to claim 22 wherein the r₅₀ is in the range of from about 0.05 to about 0.15 μm.

27. The magnesium hydroxide particles according to claim 23 wherein said magnesium hydroxide particles have a linseed oil absorption in the range of from about 16% to about 25%.

28. The magnesium hydroxide particles according to claim 24 wherein said magnesium hydroxide particles have a linseed oil absorption in the range of from about 20% to about 28%.

29. The magnesium hydroxide particles according to claim 25 wherein said magnesium hydroxide particles have a linseed oil absorption in the range of from about 24% to about 32%.

30. The magnesium hydroxide particles according to claim 26 wherein said magnesium hydroxide particles have a linseed oil absorption in the range of from about 27% to about 34%.

31. A flame retarded polymer formulation comprising:
a) at least one synthetic resin; and
b) a flame retarding amount of mill-dried magnesium hydroxide particles,
wherein said mill-dried magnesium hydroxide particles are produced by mill drying a filter cake comprising from about 35 to about 99 wt. % magnesium hydroxide.

32. The polymer formulation according to claim 31 wherein said at least one synthetic resin is selected from polyethylene, polypropylene, ethylene-propylene copolymer, polymers and copolymers of C₂ to C₈ olefins (α-olefin) such as polybutene, poly(4-methylpentene-1) or the like, copolymers of these olefins and diene, ethylene-acrylate copolymer, polystyrene, ABS resin, AAS resin, AS resin, MBS resin, ethylene-vinyl chloride copolymer resin, ethylene-vinyl acetate copolymer resin, ethylene-vinyl chloride-vinyl acetate graft polymer resin, vinylidene chloride, polyvinyl chloride, chlorinated polyethylene, chlorinated polypropylene, vinyl chloride-propylene copolymer, vinyl acetate resin, phenoxy resin, polyacetal, polyamide, polyimide, polycarbonate, polysulfone, polyphenylene oxide, polyphenylene sulfide, polyethylene terephthalate, polybutylene terephthalate, methacrylic resin, epoxy resin, phenol resin, melamine resin, unsaturated polyester resin, alkyd resin and urea resin and natural or synthetic rubbers, EPDM, butyl rubber, isoprene rubber, SBR, NIR, urethane rubber, polybutadiene rubber, acrylic rubber, silicone rubber, fluoro-elastomer, NBR and chloro-sulfonated polyethylene, polymeric suspensions (lattices), and the like.

33. The flame retarded polymer formulation according to claim 32 wherein said flame retarded polymer formulation comprises in the range of from about 5 wt % to about 90 wt % of the mill-dried magnesium hydroxide particles, based on the weight of the flame retarded polymer formulation.

34. The flame retarded polymer formulation according to claim 32 wherein said flame retarded polymer formulation comprises in the range of from about 20 wt % to about 70 wt % of the mill-dried magnesium hydroxide particles, based on the weight of the flame retarded polymer formulation.

35. The flame retarded polymer formulation according to claim 32 wherein said flame retarded polymer formulation comprises in the range of from about 30 wt % to about 65 wt % of the mill-dried magnesium hydroxide particles, based on the weight of the flame retarded polymer formulation.

36. The flame retarded polymer formulation according to claim 31 wherein said polymer formulation further comprises an additive selected from extrusion aids; coupling agents, barium stearate, calcium stearate, organoperoxides, dyes, pigments, fillers, blowing agents, deodorants, thermal stabilizers, antioxidants, antistatic agents, reinforcing agents, metal scavengers or deactivators, impact modifiers, processing aids, mold release aids, lubricants, anti-blocking agents; other flame retardants, UV stabilizers, plasticizers, flow aids, nucleating agents, and the like.

37. The flame retarded polymer formulation according to claim 31 wherein said mill-dried magnesium hydroxide particles have a d₅₀ of less than about 3.5 μm.

38. The flame retarded polymer formulation according to claim 37 wherein said mill-dried magnesium hydroxide particles have a BET specific surface area in the range of from about 1 to about 15 m²/g.

39. The flame retarded polymer formulation according to claim 38 wherein said mill-dried magnesium hydroxide particles have an r₅₀ in the range of from about 0.01 to about 0.5 μm.

40. The flame retarded polymer formulation according to claim 31 wherein said mill-dried magnesium hydroxide particles have an r₅₀ in the range of from about 0.01 to about 0.5 μm.

41. The flame retarded polymer formulation according to claim 39 wherein said mill-dried magnesium hydroxide particles have a linseed oil absorption in the range of from about 15% to about 40%.

42. A molded or extruded article made from the flame retarded polymer formulation of claim 31.

43. The molded or extruded article according to claim 42 wherein said article is a molded article, said molded article produced by i) mixing the synthetic resin and mill-dried magnesium hydroxide particles in a mixing device selected from a Buss Ko-kneader, internal mixers, Farrel continuous mixers, twin screw extruders, single screw extruders, and two roll mills thus forming a kneaded mixture, and ii) molding the kneaded mixture to form a molded article.

44. The molded article according to claim 43 wherein said molded article is used in stretch processing, emboss processing, coating, printing, plating, perforation or cutting.

45. The molded article according to claim 43 wherein the kneaded mixture is inflation-molded, injection-molded, extrusion-molded, blow-molded, press-molded, rotation-molded or calender-molded.

46. The molded or extruded article according to claim 43 wherein said article is an extruded article.

47. The molded or extruded article according to claim 46 wherein said extruded article produced by i) compounding the synthetic resin and mill-dried magnesium hydroxide particles to form a compounded mixture, ii) heating said compounding mixture to a molten state in an extruding device, and iii) extruding the molten compounding mixture through a selected die to form an extruded article or coating a metal wire or a glass fiber used for data transmission with the molten compounding mixture.
